(19) United States
(12) Patent Application Publication
(10) Pub. No.: US 2011/0120972 A1
(43) Pub. Date: May 26, 2011

(54) REPLACEMENT PROCESS FOR FLUORIDE ION CLEANING

(75) Inventors: Mark Faulkner, San Antonio, TX (US); Len Hampson, San Antonio, TX (US)

(73) Assignee: MEYER TOOL, INC., Cincinnati, OH (US)

(21) Appl. No.: 12/623,057

(22) Filed: Nov. 20, 2009

(51) Int. Cl. B44C 1/22

(52) U.S. Cl. 216/57

(57) ABSTRACT

Processes for removing a metal oxide product from a crack with an opening in an outer surface of a part, such as a turbine component. The process includes exposing the metal oxide product to a solution effective to remove a first portion of the metal oxide product from surfaces inside the crack. After the metal oxide product is exposed to the solution, the metal oxide product is heated to a temperature and in an atmosphere effective to remove a second portion of the thermal oxide product from the surfaces inside the crack. The cleaning process may be a substitute for fluoride ion cleaning.

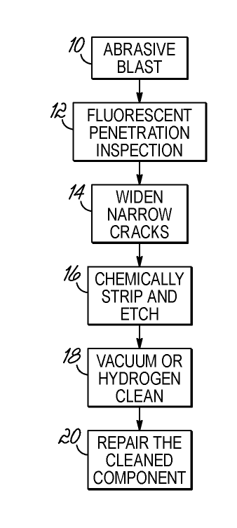

### BACKGROUND

The invention generally relates to cleaning methods and, more particularly, relates to methods for removing the metal oxide buildup from thermal fatigue cracks in turbine components used in jet engines and industrial gas turbines.

Thermal fatigue cracks form in the superalloy material of turbine components in jet engines (aerospace applications) and industrial gas turbines because of high temperatures and cyclic stresses experienced during service. When jet engines and industrial gas turbines are overhauled, the turbine components may be subjected to various repair operations. For example, a brazing operation like liquid phase sintering or diffusion brazing may be utilized to repair the cracks in the superalloy material. However, to improve the effectiveness of the repair, complex metal oxide products that form in the cracks during service must be removed because the braze will not otherwise wet and penetrate into the crack. If the brazing operation is not effective, then the integrity or quality of the turbine component may be compromised.

The dynamic Fluoride Ion Cleaning (FIC) method was developed as a thermo-chemical cleaning process for preparing the surfaces of turbine components for repair. FIC is particularly effective for removing metal oxide products residing in thermal fatigue cracks before brazing techniques are used to repair the cracks. In a conventional FIC batch process, a group of the turbine components is placed in a cleaning chamber of a reactor, heated to a temperature of approximately 1000° C., and exposed to a gas atmosphere containing gaseous fluorine compounds. A commonly used gas is anhydrous hydrogen fluoride (HF gas) that dissociates to form fluoride ions. Elemental fluorine, which is the most chemically reactive and electronegative of all the elements, reduces the metal oxides resident in the thermal fatigue cracks. Generally, FIC processes leave the superalloy material intact.

Despite their general effectiveness, FIC processes have certain disadvantages. FIC requires a high capital cost for reactors and hazardous gas controls. FIC also raises health and safety issues related to the handling and use of hydrogen fluoride. FIC has also been observed to cause alloy depletion and intergranular attack in the superalloy material in regions of turbine components. If the turbine component is mounted as a rotating part in the jet engine or industrial gas turbine, then alloy depletion and intergranular attack are concerns because the turbine component is subjected to high centrifugal forces that can result in failure from compromised mechanical properties.

What is needed, therefore, are processes and methods for cleaning turbine components that improve upon the conventional FIC methods.

### SUMMARY OF THE INVENTION

Embodiments of the invention are generally directed to processes and methods for cleaning or removing metal oxide products from cracks in a turbine component as an alternative to, or replacement for, cleaning with conventional FIC methods. The cleaned turbine component may then be more effectively repaired, rather than replaced, which lengthens the service life. Turbine component repair conserves the costly superalloy material and provides a significant cost advantage over replacement.

In one embodiment, a process is provided for removing a metal oxide product from a crack with an opening in an outer surface of a part. The process includes exposing the metal oxide product to a solution effective to remove a first portion of the metal oxide product from surfaces inside the crack. After the metal oxide product is exposed to the solution, the metal oxide product is heated to a temperature and in an atmosphere effective to remove a second portion of the thermal oxide product from the surfaces inside the crack.

The process embodiments of the invention are metallurgically similar and operationally superior to FIC cleaning because the superalloy material is not subject to intergranular attack. The process embodiments of the invention cause minimal loss of the superalloy material, which is a benefit because certain minimum dimensions must be maintained to prevent a turbine component from being categorized as non-repairable and compulsorily retired from service. The process embodiments of the invention are capable of cleaning to the bottom of the deepest and/or narrowest cracks. In comparison with FIC, the embodiments of the invention do not raise health and safety issues because hydrogen fluoride is not handled and used.

### BRIEF DESCRIPTION OF THE DRAWINGS

The FIGURE is a flow chart for a method in accordance with an embodiment of the invention.

### DETAILED DESCRIPTION

The embodiments of the invention are applicable for cleaning jet engine and industrial generation turbine components, such as blades, vanes, shrouds, and nozzles, composed of a superalloy material including, but not limited to, nickel-based or cobalt-based high temperature superalloy materials that can have a single crystal, a directionally solidified, or equiaxed microstructure. In each instance, the primary constituent of the superalloy material is the base metal, nickel (Ni) or cobalt (Co). The compositions of most common superalloy materials also include one or more elements selected from tungsten (W), hafnium (Hf), iron (Fe), molybdenum (Mo), titanium (Ti), rhenium (Re), tantalum (Ta), niobium (Nb), chromium (Cr), or aluminum (Al). Generally, superalloy materials are known for high-temperature performance in terms of tensile strength, creep resistance, oxidation resistance, and corrosion resistance.

During use, each turbine component is mounted in a jet engine or in an industrial gas turbine. Each turbine component may be classified as either a rotating part or a non-rotating part in the jet engine or industrial gas turbine. Jet engines and industrial gas turbines are periodically overhauled to ensure continued safe operation. During overhaul, aged turbine components are removed from the jet engine or industrial gas turbine and may be repaired to prolong part life as an alternative to replacement with new parts.

Each aged turbine component may include narrow cracks, which are intended to include crevices and other close tolerance surface-breaking depressions in the outer surface of the turbine component having an opening that intersects the outer surface. A percentage of the cracks have a measurable average width of 0.125 inch or less, and other cracks may have slightly larger measurable average widths of up to about 0.5 inch. The depth of the cracks is arbitrary, but each crack typically has a bottom that is recessed by a finite distance relative to the outer surface of the turbine component. These surface breaking cracks may be, for example, thermal fatigue cracks formed in the superalloy material because of high temperatures and cyclic stresses experienced during service in a jet engine or industrial gas turbine.

Each crack has surfaces that border an open space and some of these surfaces intersect the outer surface. The surfaces of the narrow surface breaking cracks are at least partially covered by metal oxides products, which are developed during service. The metal oxide products, which may have various compositions, must be cleaned from the surfaces of the cracks to promote an effective repair.

With reference to the FIGURE, a turbine component is subjected to a process that prepares the cracks and outer surface for repair by, for example, brazing or another material addition process.

In block 10, the turbine component is subjected to an initial gross cleaning operation that removes service induced contaminants, such as surface soils and loose oxide scales, from the outer surface. In one embodiment, abrasive blasting or grit blasting may be employed to remove the service induced contaminants. Generally, abrasive blasting is the operation of forcibly propelling a stream of an abrasive material, such as dry alumina grit, against the outer surface of the turbine component. The impact of the abrasive material mechanically removes the service induced contaminants. The abrasive blasting operation is controlled to minimize any loss of the superalloy material from the turbine engine component.

After the initial gross cleaning operation is used to prepare the outer surface of the turbine component, the locations of the surface-breaking cracks in the superalloy material are identified in block 12. In one embodiment, the turbine component is subjected to a Fluorescent Penetrant Inspection (FPI) in order to identify cracks. An FPI operation, which is understood by a person having ordinary skill in the art, involves applying a penetrant fluid containing a fluorescent dye to the outer surface of the turbine component and waiting for a dwell time (e.g., 10 minutes to 30 minutes) sufficient to permit the penetrant fluid to infiltrate by capillary action into the surface breaking cracks. The penetrant fluid may be applied to the turbine component by dipping, spraying, brushing, or another conventional technique. The preparatory abrasive blasting operation rids the outer surface of contamination that may otherwise fill a surface breaking crack or potentially provide a false indication of a surface breaking defect. Ridding the surfaces of undesired contaminates ensures penetration into the surface breaking cracks that open to the outer surface when the penetrant fluid is applied.

Excess penetrant fluid is carefully removed primarily from the outer surface bordering the cracks, but not from inside the cracks themselves. In one embodiment, the turbine component is subjected to a bake-out, a power wash, or both to remove to remove excess penetrant fluid. In another embodiment, the turbine component is immersed in a bath of sodium hydroxide, which is heated to, e.g., about 140° F. In alternative embodiments, other types of non-destructive techniques may be employed to perform crack identification as an alternative to FPI.

After excess penetrant fluid is removed, the turbine component is thoroughly dried in, for example, an oven or other heated enclosure. After drying, a developer is applied to the outer surface of the turbine component. The developer may have the form of a dry powder, a water soluble compound, a suspension, or a non-aqueous liquid applied by spraying or dipping. The developer extracts the penetrant fluid slightly out of each of the surface breaking cracks so that a portion of the penetrant fluid bleeds onto the adjacent outer surface. The developer also may provide a background that enhances the visibility of the fluorescent dye in the penetrant fluid. The enhanced visibility of the fluorescent dye on the contrast-enhanced background of the outer surface improves the visibility of the surface breaking cracks for identification.

After a time delay for the developer to properly function, the turbine component is inspected using radiation from an ultraviolet (e.g., UVA) lamp. When exposed to the ultraviolet radiation, the fluorescent dye in the penetrant fluid in, and about, each surface breaking crack appears as a bright object on a dark field. The visible indication from the fluorescent dye in the penetrant fluid is easier for the human eye to discern than the native cracks under normal lighting conditions. The locations of the surface breaking cracks are mapped so that the locations are visually identifiable under normal lighting conditions. In one embodiment, the surface breaking cracks are marked with a marking device, such as an ink marker, to create the defect map. The resultant map of the surface breaking cracks in the superalloy material lacks any depth information. The turbine component is cleaned using a liquid capable of removing the penetrant fluid from the outer surface and cracks without removing the markings in the defect map.

In block 14, a mechanical material removal operation is used to widen either all surface breaking cracks or only surface breaking cracks that are narrower than a selected minimum width. In one embodiment, the mechanical operation entails the use of a small section hand tool, such as a DREMEL rotary tool and grinding attachment commercially available from the Robert Bosch Tool Corporation, or a pneumatic hand grinder to widen the surface breaking cracks. In one embodiment, only cracks of a minimum average width, such as approximately 0.125 inch in average width and narrower, are selected for widening. This representative manual grinding operation is directed to removing superalloy material from the outer surface about the crack so that the opening to each narrow surface breaking crack is widened. However, the mechanical material removal operation is conducted while minimizing the removed amount of the superalloy material.

The widening of the narrow surface breaking cracks improves the effectiveness of a subsequent acid exposure by permitting the acid solution to penetrate to the defect bottom or through the crack if the crack extends through the component. This manual surface preparation operation also permits the braze slurry used as a filler in repair to penetrate to the defect bottom.

In block 16, after the narrow surface breaking cracks are widened, the turbine component is exposed to an acid solution in a chemical strip/etch operation. In one embodiment, the acid solution is composed of concentrated hydrochloric acid (50 vol. %-75 vol. % concentration) and balance de-ionized water at a temperature of 120° F. to 150° F., and the turbine components are continuously immersed in the acid solution for a period of up to two (2) hours maximum. Hydrochloric acid is a highly aggressive reducing acid, which are generally preferred over oxidizing acids. In one embodiment, hydrochloric acid constitutes the only acid in the composition of the acid solution.

In addition to or instead of hydrochloric acid, the acid solution may contain other acids including, but not limited to, nitric acid, hydrofluoric acid, and sulfuric acid. For example, one suitable mixture for the acid solution is aqua regia formed by mixing concentrated hydrochloric acid and concentrated nitric acid, usually in a volumetric ratio of about 3:1. For increasing the activity of the acid solution, these principle acids can be enhanced with weaker acidic solutions, such as picric acid, oxalic acid, acetic acid, phosphoric acid, perchloric acid, or chromic acid, and metal or salt additives, such as ferric chloride, cupric chloride, copper sulfate, sodium chloride, sodium sulfate, ammonium bifluoride, ammonium fluoride, potassium hydroxide, sodium hydroxide, potassium ferricyanide, or hydrogen peroxide. After removal from the acid solution, the turbine component is rinsed and dried.

Exposure to the acid solution chemically removes a portion of each of the metal oxide products inside the cracks by etching and/or stripping action in advance of the subsequent vacuum or hydrogen cleaning operation. The acid exposure also breaks down and modifies the structure of the metal oxide products in the surface breaking cracks so that the effectiveness of the subsequent vacuum or hydrogen cleaning operation is enhanced. The structural integrity of the metal oxide products in each crack is compromised such that the metal oxide products are more susceptible to removal by the vacuum or hydrogen cleaning process. Metal oxide products on the outer surface of the turbine component are also at least partially removed and have their structural integrity compromised by the acid solution exposure.

In block 18, following the chemical modification, the turbine component is then subjected to either a high-temperature vacuum cleaning operation or a high-temperature hydrogen cleaning operation. The vacuum cleaning operation or hydrogen cleaning operation places the turbine component in a suitable atmosphere or environment and, while in the atmosphere or environment, heats the turbine component and metal oxide products to a temperature conducive to removing the metal oxide products from the surfaces of the surface breaking cracks. The typical mode of removal is as vapor phase or gaseous reaction products. The metal oxide products in each crack are modified structurally by the preceding acid exposure, which promotes their removal. Metal oxide products are also removed from the outer surface of the turbine component by the vacuum or hydrogen cleaning. Preferably, substantially all of the metal oxide products are removed from the outer surface of the turbine component and the surfaces of each of the cracks.

In one embodiment, the turbine component is placed into the enclosed or contained environment of a heat treatment furnace or retort and then the turbine component and metal oxide products are heated to an elevated temperature under vacuum conditions (i.e., a pressure below atmospheric pressure or a partial pressure atmosphere). In one specific embodiment for a vacuum cleaning operation, the environment of the heat treatment furnace is evacuated to a vacuum pressure of 10⁻⁴ Torr to 10⁻⁵ Torr, and the turbine component and modified metal oxide products are heated to a temperature of 2250° F.±25° F. for a soak time of two (2) hours or less.

In another embodiment, the turbine component is placed into the enclosed or contained environment of a retort furnace or a heat treatment furnace and then the turbine component and metal oxide products are heated to an elevated temperature in a reducing environment (i.e., a partial pressure hydrogen (H₂) atmosphere, an atmospheric hydrogen pressure, or a slight positive hydrogen pressure). In hydrogen cleaning, the hydrogen chemically reacts with the structurally-modified metal oxide products to form gases or vapors that are released from the surface breaking cracks and outer surface. In one specific embodiment of a hydrogen cleaning operation, argon (Ar) is flowed into the contained environment of a retort furnace to purge oxygen, the temperature is raised toward 2250° F., hydrogen is introduced at 1400° F. during the temperature ramp, and the turbine component and metal oxide products are held in the reducing environment at a temperature of 2250° F.±25° F. for a soak time of two (2) hours or less. In another embodiment of a hydrogen cleaning operation, a partial pressure of hydrogen is introduced into a previously-evacuated heat treatment furnace at a temperature of about 1400° F. as the temperature is ramped toward 2250° F., and the turbine component and the structurally-modified metal oxide products are held in the hydrogen partial pressure at a temperature of 2250° F.±25° F. for a soak time of two (2) hours or less.

The vacuum cleaning operation may be particularly useful for turbine components composed of cobalt-based superalloy materials. The hydrogen cleaning operation may be particularly useful for turbine components composed of nickel-based superalloy materials because the types of metal oxides developed on the surfaces of the cracks are more difficult to remove than from crack surfaces of cobalt-based superalloy materials.

Typically, the acid exposure and the vacuum or hydrogen cleaning operation are performed in succession only once on each turbine component. However, these operations may be iterated if needed. The acid exposure and vacuum or hydrogen cleaning operation are ordered chronologically such that the acid exposure is performed before the vacuum or hydrogen cleaning operation. The acid exposure chemically modifies the structure of the metal oxide products on the surfaces of the cracks such that the metal oxide products are more susceptible to removal by the vacuum or hydrogen cleaning operation. For example, the structural modification of the metal oxide products promotes penetration of hydrogen in, around and beneath the metal oxide products, or the communication with the vacuum environment. The volatile reaction products released as a gas or vapor from the turbine component are evacuated from the heat treatment furnace or retort by a vacuum pump.

The turbine component is then allowed to cool to room temperature and removed from the heat treatment furnace or retort.

In block 20, the cleaned turbine component is repaired. In one embodiment, a brazing operation is then used to fill the cleaned surface breaking cracks and effect crack repair. An exemplary brazing operation is liquid phase sintering or diffusion brazing, which is a hybrid brazing process that relies on the melting and flow of a braze during a heat treatment into the cleaned surface breaking cracks in order to fill the cracks. The braze may be composed of a powdered high-strength metal alloy and a melting point depressant that promotes penetration of the powdered metal alloy into the depth of the cleaned surface breaking cracks. The metal alloy in the braze may have a composition similar to the composition of the constituent superalloy material of the turbine component.

During the brazing operation, the powdered metal is applied to the surface of the turbine component and heated with a heat treatment in a furnace to a molten state. The molten metal in the liquid phase wets and adheres to the clean surface of the turbine component and infiltrates into the cleaned surface breaking cracks. After solidification occurs, the braze material supplies a material addition that fills the cracks. The repaired cracks may exhibit mechanical properties approximating those of the superalloy base metal of the turbine component.

Alternatively, the cracks on the cleaned turbine component may also be welded to add filler material. An optional brazing operation may be applied to welded cracks to fill any remaining open space.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “composed”, or variants thereof are used in either the detailed description or the claims, such terms are intended to be inclusive in a manner similar to the term “comprising”.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

What is claimed is:

1. A process for removing a metal oxide product from a crack with an opening in an outer surface of a part, the process comprising:
exposing the metal oxide product to a solution effective to remove a first portion of the metal oxide product from surfaces inside the crack; and
after the metal oxide product is exposed to the solution, heating the metal oxide product to a temperature and in an atmosphere effective to remove a second portion of the thermal oxide product from the surfaces inside the crack.

2. The process of claim 1 further comprising:
before exposing the turbine component to the solution, identifying the crack; and
after the crack is identified, marking the crack.

3. The process of claim 2 further comprising:
before exposing the turbine component to the solution, removing material from the turbine engine component that borders the surfaces of the crack in order to widen the opening in the outer surface of the turbine component to the crack.

4. The process of claim 3 wherein removing the material from the turbine engine component comprises:
removing a portion of the outer surface of the turbine engine component proximate to the opening to the crack.

5. The process of claim 4 wherein removing the portion of the outer surface further comprises:
using a hand tool to grind the outer surface of the turbine engine component about the opening to the crack.

6. The process of claim 2 wherein the crack is identified using Fluorescent Penetrant Inspection, and the crack is marked for visualization in normal lighting.

7. The process of claim 1 wherein heating the metal oxide product comprises:
placing the turbine component in a reducing atmosphere; and
while the turbine component is in the reducing atmosphere, elevating the temperature of the metal oxide product.

8. The process of claim 7 wherein the reducing atmosphere contains hydrogen, and the metal oxide product is reduced by a chemical reaction with the hydrogen at the elevated temperature.

9. The process of claim 8 wherein the temperature of the metal oxide product is elevated to a temperature of 2250° F.±25° F., and the metal oxide product is held at the temperature of 2250° F.±25° F. for a soak time of two (2) hours or less.

10. The process of claim 7 wherein the hydrogen in the reducing environment is at approximately atmospheric pressure.

11. The process of claim 10 wherein the temperature of the metal oxide product is elevated to a temperature of 2250° F.±25° F., and the metal oxide product is held at the temperature of 2250° F.±25° F. for a soak time of two (2) hours or less.

12. The process of claim 7 wherein the hydrogen in the reducing environment is below atmospheric pressure.

13. The process of claim 1 wherein heating the metal oxide product comprises:
placing the turbine component in an evacuated environment; and
while the turbine component is in the evacuated environment, elevating the temperature of the metal oxide product.

14. The process of claim 13 wherein the evacuated environment has a vacuum pressure of 10⁻⁴ Torr to 10⁻⁵ Torr, the metal oxide product is heated to a temperature of 2250° F.±25° F., and the metal oxide product is held at the temperature of 2250° F.±25° F. for a soak time of two (2) hours or less.

15. The process of claim 1 wherein the solution is an acid solution.

16. The process of claim 15 wherein the acid solution contains hydrochloric acid and no other acid.

17. The process of claim 15 wherein the acid solution includes concentrated hydrochloric acid and de-ionized water.

18. The process of claim 1 wherein, after heating the metal oxide product, substantially all of the metal oxide product is removed from the surfaces of the crack.
